(19) United States
(12) Patent Application Publication
(10) Pub. No.: US 2013/0215093 A1
(43) Pub. Date: Aug. 22, 2013

(54) Power-Optimized Image Improvement In Transflective Displays

(71) Applicants: Johan L. Bergquist, Tokyo (JP); Klaus M. Melakari, Oulu (FI)

(72) Inventors: Johan L. Bergquist, Tokyo (JP); Klaus M. Melakari, Oulu (FI)

(73) Assignee: Nokia Corporation

(21) Appl. No.: 13/399,145

(22) Filed: Feb. 17, 2012

(51) Int. Cl. G06F 3/038; G09G 3/30

(52) U.S. Cl. 345/207

(57) ABSTRACT

The specification and drawings present a new method, apparatus and software related product (e.g., a computer readable memory) for improving quality (e.g., eliminating parallax and/or increasing contrast) of an observed image in displays (e.g., transflective displays) in a reflective mode by creating at least one complimentary image based on measurements of ambient light luminance and/or diffusivity as well as minimizing the power necessary to achieve readability in low ambient light. In one embodiment the parallax (shadow) image may be inverted and displayed on the emissive display to cancel the parallax image. In another embodiment an improvement of readability (e.g., thus improving contrast) of a positive polarity text/graphic image on the LCD may be accomplished by using an inverted blurred version of the same image multiplied with the original image.

### TECHNICAL FIELD

The exemplary and non-limiting embodiments of this invention relate generally to electronic displays and more specifically to improving quality of an observed image (e.g., eliminating parallax, increasing contrast under dim conditions) in transflective displays, while minimizing power consumption.

### BACKGROUND ART

The following abbreviations that may be found in the specification and/or the drawing figures are defined as follows:
ALS ambient light sensor
E-book electronic book
ITO indium tin oxide
LCD liquid crystal display
MEMS micro-electro-mechanical systems
OLED organic light-emitting diode
RBG red, blue and green
TF-OLED transflective OLED

Image quality (e.g., no parallax, high contrast) in the observed image in electronic displays (e.g., transflective displays) as well as minimization of the power consumption are important areas for improvement of display performance.

### SUMMARY

According to a first aspect of the invention, a method comprising: measuring at least one of ambient light illuminance, ambient light diffusivity and an ambient light white point of ambient light incident on a transflective display having an upper display operating in a reflective mode; creating at least one complimentary image based on the at least one of the measured ambient light illuminance and the measured ambient light diffusivity and ambient light white point; and lighting up selected pixels in a lower display of the transflective display, using the at least one complimentary image.

According to a second aspect of the invention, an apparatus comprising: at least one processor and a memory storing a set of computer instructions, in which the processor and the memory storing the computer instructions are configured to cause the apparatus to: measure at least one of ambient light illuminance, ambient light diffusivity and an ambient light white point of ambient light incident on a transflective display having an upper display operating in a reflective mode; create at least one complimentary image based on the at least one of the measured ambient light illuminance and the measured ambient light diffusivity and ambient light white point; and light up selected pixels in a lower display of the transflective display, using the at least one complimentary image.

According to a third aspect of the invention, a non-transitory computer readable memory encoded with a computer program comprising computer readable instructions recorded thereon for execution of a method comprising: measuring at least one of ambient light illuminance, ambient light diffusivity and an ambient light white point of ambient light incident on a transflective display having an upper display operating in a reflective mode; creating at least one complimentary image based on the at least one of the measured ambient light illuminance and the measured ambient light diffusivity and ambient light white point; and lighting up selected pixels in a lower display of the transflective display, using the at least one complimentary image.

### BRIEF DESCRIPTION OF THE DRAWINGS:

For a better understanding of the nature and objects of the present invention, reference is made to the following detailed description taken in conjunction with the following drawings, in which:

FIGS. 1a and 1b are diagrams of displays demonstrating observed image without parallax (FIG. 1a) and with parallax (FIG. 1b);

FIG. 2 is a diagram of a dual-image plane transflective display in a reflective mode demonstrating parallax problem;

FIG. 3: is an E-book screen image with a positive polarity in emissive or transmissive mode;

FIG. 4: is an E-book screen image with a negative polarity;

FIGS. 5a-5c are diagrams of a dual-image plane transflective display in a reflective mode with parallax (FIG. 5a), with construction of an inverse parallax image (FIG. 5b) and with elimination of parallax/shadowing by lighting up selected emissive/transmissive display pixels (FIG. 5c), according to exemplary embodiments of the invention;

FIG. 6 is an E-book screen image in a reflective mode and under dim light;

FIG. 7 is a low-pass filtered E-book screen image for achieving a local contrast enhancement shown in FIG. 8, according to an exemplary embodiment of the invention;

FIG. 8 is an E-book screen image with a local contrast enhancement, according to an exemplary embodiment of the invention;

FIG. 9 is a flow chart demonstrating implementation of exemplary embodiments of the invention for eliminating parallax in a reflective mode;

FIG. 10 is a flow chart demonstrating implementation of exemplary embodiments of the invention for the local contrast enhancement in a reflective mode; and

FIG. 11 is a block diagram of wireless devices for practicing exemplary embodiments of the invention.

### DETAILED DESCRIPTION

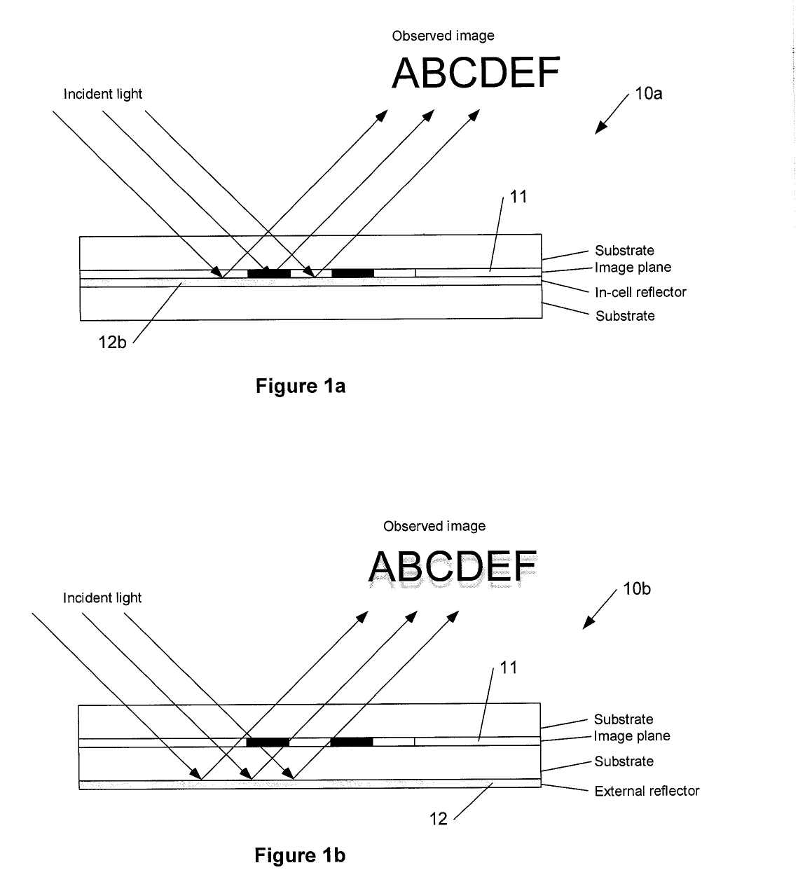

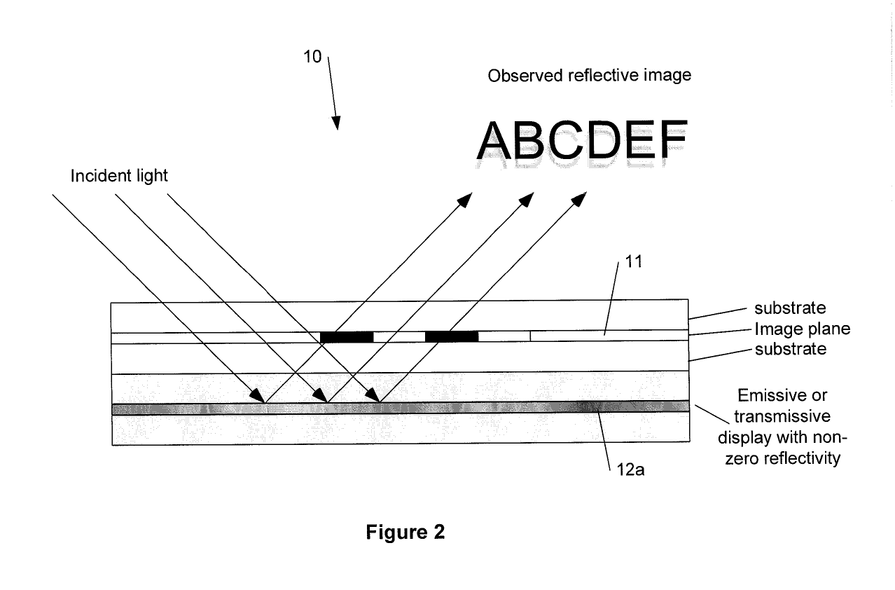

By way of introduction, dual-image plane transflective displays comprising an upper transmissive/reflective display and a lower emissive/transmissive display with a non-zero reflectance, acting as a reflector of the upper display, 10b and 10, shown in corresponding FIGS. 1b and 2, with the reflective display image plane 11 (e.g., pixelated retarder plane in an LCD) separated by a vertical distance from the reflector/emitter 12 or 12a shown in FIGS. 1b or 2 suffer from parallax when viewed in a pure reflective mode. As a result, text is shadowed and appears blurred as shown in FIGS. 1b and 2. The higher the pixel/text density, the larger the parallax becomes. FIG. 2 is similar to FIG. 1b but the external reflector 12 in FIG. 1b is equivalent to the emissive/transmissive display image plane 12a in FIG. 2.

This parallax problem has been addressed in reflective and transflective LCDs by locating the reflector 12b inside the liquid crystal next to the reflective image plane 11 of the display 10a in FIG. 1a, so the display 10a does not have the parallax problem. However, this increases mask count and material consumption and thus production cost, and reduces yield since color filters may become damaged. Also, transflective LCDs suffer from a trade-off between pixel density and color gamut on one hand, and reflectance and transmittance/power consumption on the other hand.

Moreover, in the transflective OLEDs (e.g., see PCT Patent Application Publication WO2011107826A1), or other dual image-plane transflective display with a reflecting lower emissive/transmissive display, parallax may be reduced by reducing the substrate thicknesses of the upper display and lower display substrates. This also applies to the case of a transparent OLED laminated on top of a reflective display, i.e., a reverse transflective OLED (e.g., see US Patent Application Publication US2011267279A1). The OLEDs can be encapsulated by a thin film instead of a thicker glass, and they will hence not contribute to the parallax. However, the bottom substrate is always thicker and hence contributes to the parallax in the reverse transflective OLED case.

The parallax by the LCD may be reduced by making the LCD substrate thinner However, thinner glass substrates would make the display more fragile. Plastic substrates are thin and durable but they cannot withstand the temperatures necessary for depositing, e.g., ITO electrodes. Also making the LCD directly on top of the OLED is not possible since the process temperature of the LCD is higher than what the OLED layers can withstand.

Furthermore, readability in the reflective mode of the transflective displays may be low because the luminance of the reflected ambient light is insufficient. Illuminating the entire background or replicating the image of the upper display by the lower emissive/transmissive display provides the necessary luminance and contrast but increases the power consumption, particularly if the background is white.

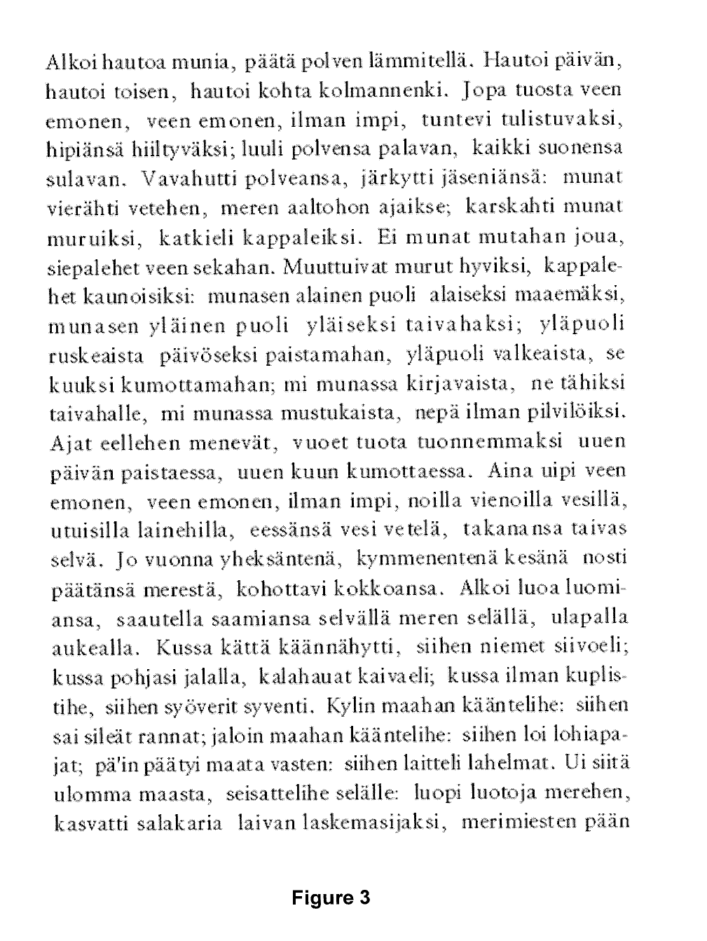

Transmissive LCDs, emissive displays such as conventional OLEDs, or transflective OLEDs in an emissive mode (all LCD pixels switched to black) achieve readability under ambient light by increasing the emissive luminance. This increases power consumption, particularly for a text with positive polarity (dark text on bright background), the preferred polarity for long reading tasks such as E-books and web pages. The number ratio between dark and bright pixels on a typical E-book page (see FIG. 3) is about 1:8.

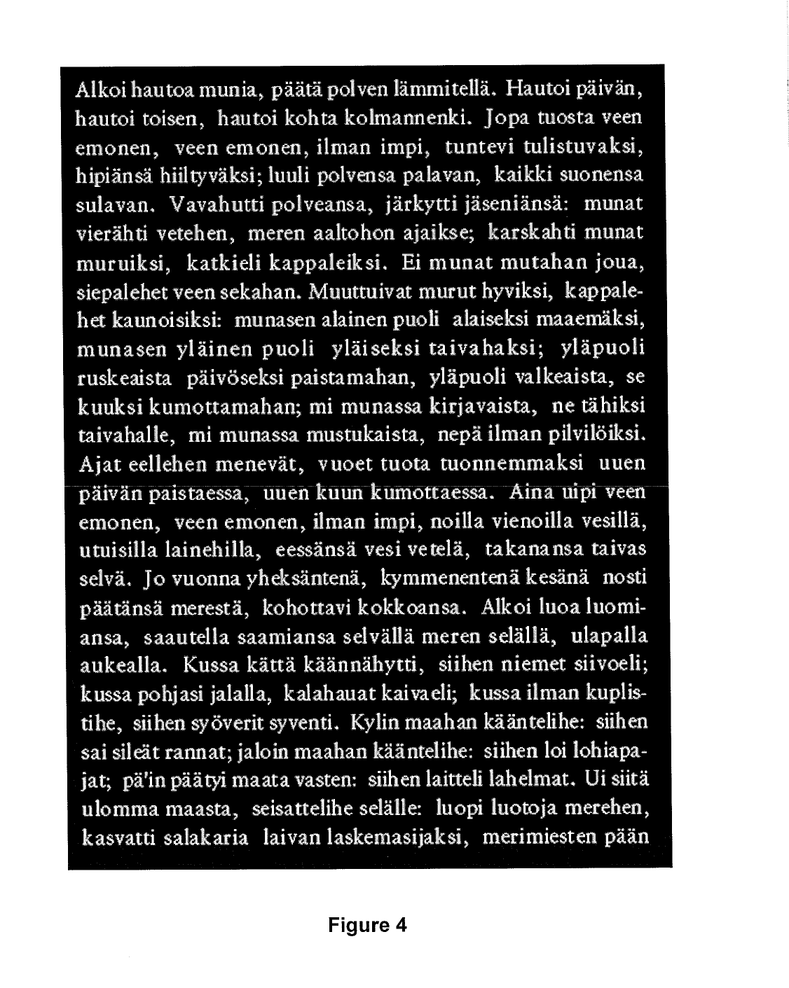

In the transflective mode of a dual image-plane transflective display, the lower display shows the same image as in the emissive mode but at a lower luminance since the background luminance is the sum of the luminance of the emitted light and of the reflected ambient light. Although the luminance of the emitted light can be lower compared to the emissive case for achieving the same contrast in ambient light, the number of bright pixels is the same. To reduce the number of bright pixels, the image polarity can be reversed, i.e. bright text on a dark background as shown in FIG. 4. However, this is not ergonomically sound for long reading tasks.

It is noted that for the purpose of this invention the term “light” identifies a visible part of the optical spectrum.

A new method, apparatus, and software related product (e.g., a computer readable memory) are presented for improving quality (e.g., eliminating parallax and/or increasing contrast) of an observed image in displays (e.g., transflective displays) in a reflective mode by creating at least one complimentary image based on measurements of ambient light illuminance and/or diffusivity, as well as minimizing the power necessary to achieve readability in low ambient light.

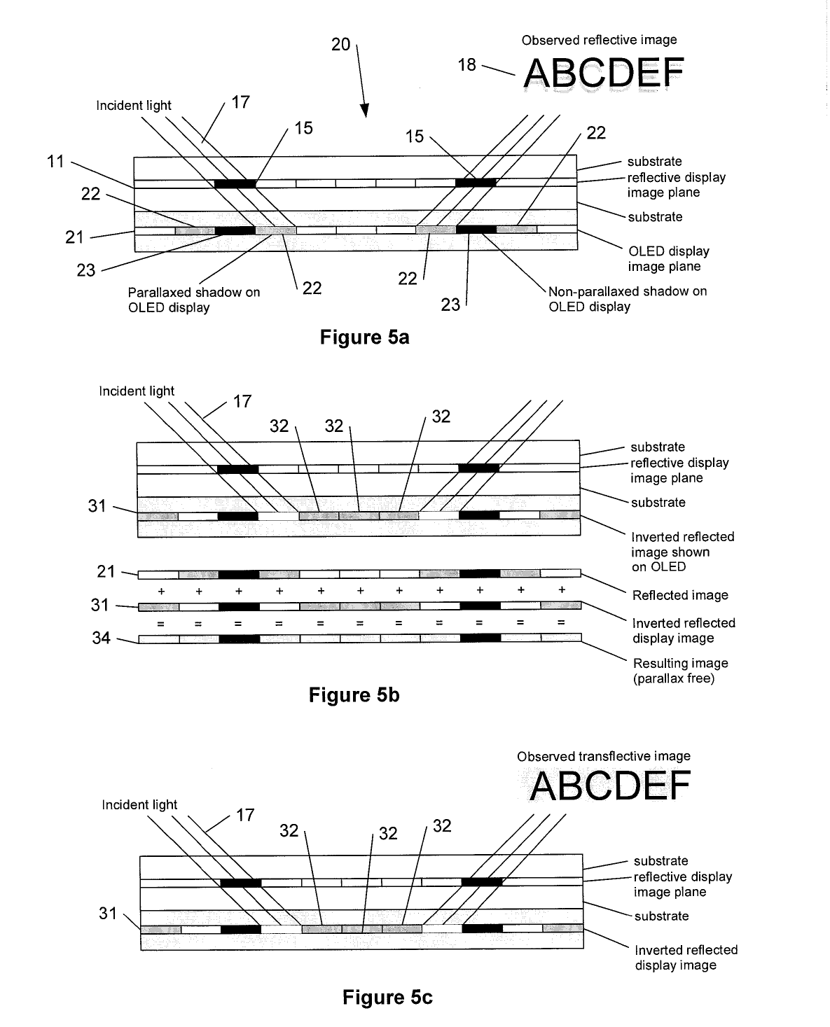

In a first embodiment the parallax (shadow) image may be inverted and displayed on the emissive/transmissive display to cancel the parallax image as demonstrated in FIGS. 5a-5c. The plane 11 (or upper display) in FIGS. 1b, 2 and 5a-5c can be also called a “spatial light amplitude modulator” which may be implemented using different display technologies, e.g., retardation-based LCD with polarizers, electro-chromic displays, polymer-dispersed LCDs, MEMS, anisotropic dye-doped LCDs.

FIGS. 5a-5c show diagrams of a dual-image plane transflective display 20 in the reflective mode with parallax in FIG. 5a (similar to FIG. 2), with construction of an inverse parallax image shown in FIG. 5b and with elimination of parallax/shadowing by lighting up selected lower emissive/transmissive display pixels in FIG. 5c, according to exemplary embodiments of the invention;

An emissive/transmissive display image plane 21 (a lower display) shown in FIG. 5a is emissive display with non-zero reflectance but generally may be transmissive, reflective or transflective plane with non-zero reflectance. Incident light 17 (e.g., near collimated/from a point light source) is incident on the display 20 at relatively large angles (relative to the normal of the display 20). The incident light 17 reflected from non-white pixels 15 on the reflective display 11 forms the image 18 (ABCDEF).

The emissive/transmissive display pixels 23 below the non-white pixels 15 of the reflective display 11 are black (not blurred). These emissive/transmissive display pixels coincide with the non-parallaxed shadow on the emissive/transmissive display image plane 21 as shown in FIG. 5a. However, pixels 22 form a parallaxed shadow of the pixels 15 on the emissive/transmissive display image plane 21 and create a parallaxed shadow of the observed image 18.

This parallax image of the emissive/transmissive display image plane 21 may be calculated from the measured ambient light illuminance, emissive/transmissive display reflectance (known for the spectral region of interest), and a Gaussian blurred reflective display image. The amount of Gaussian blur depends on the distance between the reflective planes 11 and 21 and the spatial distribution of the ambient light. The latter can be estimated from the type of light source which in turn can be determined from the ratio(s) of the at least two spectral channels of the ambient light sensor (ALS). The emissive/transmissive display emitter in this example is always in the same plane as the reflector since it is the emissive/transmissive display metal electrodes or other reflecting structures that can act as reflectors.

The image 31 in FIG. 5b consists of the image of the upper display multiplied with the inverted reflected image, where the luminance of the reflected and emitted light of the non-shadowed pixels 32 is identical to the luminance of the reflected and emitted light of the shadowed pixels 22 in FIG. 5a. Also FIG. 5b shows that resulting image 34 (parallax free) from the lower display in the transflective mode is then a sum of the images 21 and 31. In other words, pixels 22 are lighted up (e.g., lighted up more than pixels 32) for elimination of parallax/shadowing in FIG. 5c.

FIGS. 5a-5c show schematic implementation for one pixel parallax. However, for higher resolutions and/or larger incident angle of the directed ambient light, the parallax shadow may cover several pixels across which the luminance of the shadow can vary. This variation is determined by the Gaussian blur of the image displayed on the reflective display, and the diffusiveness of the ambient light. Based on the distance between the upper and lower image planes, the radius of the Gaussian blur is chosen such that the luminance of the combined reflected and emitted light of pixels 22 and 32 is identical. Then lighting levels for different pixels may be globally adjusted dependent on illuminance level to equalize the level of light intensity reflected/emitted from the shadowed parallaxed pixels and complementary background pixels.

It is further noted that the blurring applied on the image of the upper display is projected on the lower display according to the position of the point/collimated light source. The position can be measured with a front-facing camera or any other circular 1D or rectangular 2D array photodetector. The ratio between diffusive and collimated/direct light components can be determined by analyzing the image of the ambient light projected onto the array/camera. First a low-pass filter is applied and then the ratio between bright spots and background is calculated. The capturing angle of the array detector should be as wide as possible (e.g., using fisheye lens). This can also be applied to purely reflective displays whose reflective diffusiveness then can be dynamically optimized to the diffusiveness of the ambient light for maximum reflectance and contrast (e.g., see US Patent Application Publication No. 2003/01333284).

Thus the technique according to the first embodiment described herein may allow using transflective displays with relatively thick substrates to read high resolution images without parallax.

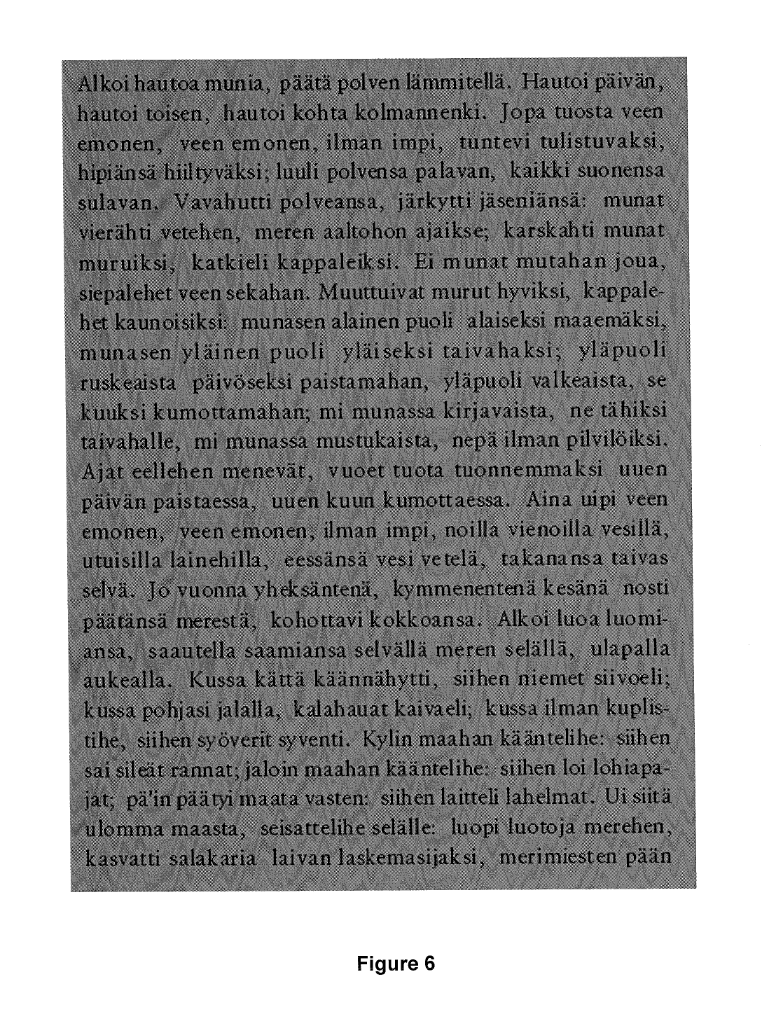

In a second embodiment an improvement of readability (as a result of increased contrast) of a positive polarity text/graphic image on the LCD may be accomplished by using an inverted blurred version of the same image multiplied with the original image as shown and explained in reference to an example shown in FIGS. 6-8. In this way, only regions around the characters (or in general fine features, texture etc.) may be backlit, and high character contrast may be achieved without turning on all pixels of the lower display. A transflective display with upper and lower displays in the reflective mode of operation shown in FIGS. 2 and 5a or the like may be also used for practicing this embodiment. The upper display (plane 11 in FIGS. 2 and 5a) in general may be a spatial light amplitude modulator implemented using different display technologies based on birefringence/retardation (LCD with polarizers), scattering (e.g. polymer-dispersed LCD), Bragg reflection (e.g. cholesteric LCDs), Fabry-Perot interference condition (e.g. MEMS), selective absorption (e.g. electro-chromic displays, anisotropic dye-doped LCDs), mechanical shutter matrix, or selective reflection such as tunable plasmonic devices. The lower display (plane 21 in FIGS. 2 and 5a) generally may be emissive, transmissive, reflective or transfective plane with a non-zero reflectance. It is further noted that this embodiment (illustrated in FIGS. 6-8) may be applied not only to the text images but to images in general such graphic art, textures, fine features, photos, video, etc.

FIG. 6 shows an E-book screen image in reflective mode and under dim ambient light which is insufficient for providing an acceptable level for readability. In this situation, i.e., the total ambient light illuminance being below a predefined threshold such as 500 lux, first, the minimum required luminance of the background may be determined from the ambient light illuminance and the reflectance of the white state of the lower display in the reflective mode. The luminance of emitted light of the lower display may be then tuned/adjusted/ to a value (which may be calculated as well) such that the luminance sum of the emitted light from the lower display and reflected ambient light corresponds to the acceptable/comfortable illuminance (a predefined value, e.g. 500 lx) for readability of images on a predefined surface, e.g. copy paper. The value of the emitted light luminance (or add-luminance) for the lower display may be calculated simply by subtracting from the luminance of the reflected light which, e.g. for 500 lux (or another predefined threshold for comfortable background illuminance), may be calculated from the reflectance of the lower display and the illuminance of the ambient light. The determined value of the add-on-luminance may be further used for implementing the second embodiment.

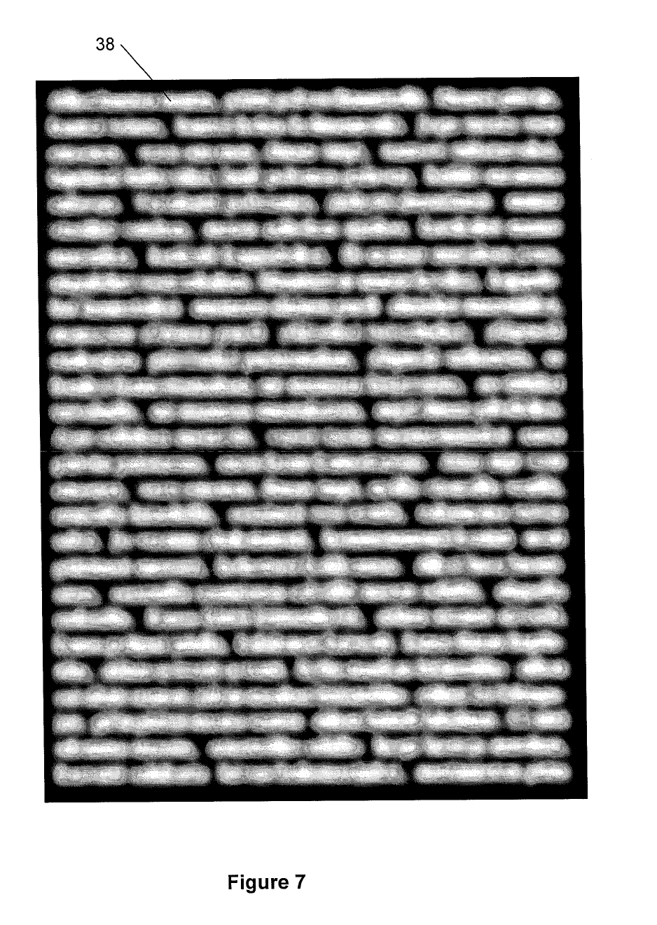

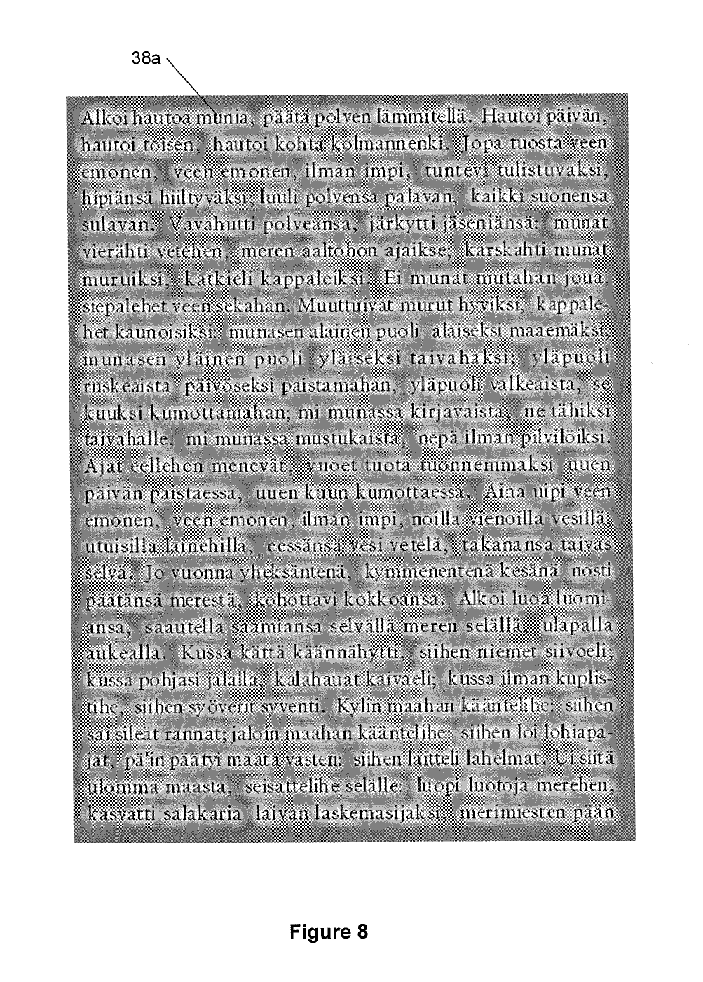

In FIG. 6 ambient light reflection is too low for achieving readability in the reflective mode so some backlighting and/or a further improvement is needed. The full scale backlighting or replicating the image of the upper display on the lower display, could consume excessive power as stated above, then according to the second embodiment of the invention high contrast/readability may be achieved based on the methodology shown and explained herein in reference to FIGS. 7-8 using a low-pass filtered inverted upper display image multiplied with the original upper display image, whose peak luminance and low-pass filtering is determined by the measured ambient light illuminance and a blurring parameter, respectively.

The criterion for applying the second embodiment (FIGS. 6-8) may be that the total ambient light illuminance is below a predefined threshold (e.g., 500 lux for a given lower display reflectance) and insufficient for providing acceptable level for readability as explained above.

A blurred and inverted version of the upper display image multiplied with the image itself (e.g., text) is then created as shown in FIG. 7, which shows the example of a blurred E-book screen image for achieving a local contrast enhancement. The amount of blur and white level depends on the text/feature size and the ambient light, respectively. The luminance of the features 38 (based on the blur size) in FIG. 7 can be the same as the value of the add-on-luminance discussed above. It is noted that FIG. 7 only shows the blurred inverted image of the upper display, not its product with the original upper display image.

FIG. 8 shows an E-book screen image generated by the product of the upper display and the lower display with local character contrast enhancement. The image on the lower display is identical to that of FIG. 8 except that the grey levels are not biased, i.e., the grey in FIG. 8 is black, and the white has lower luminance. In FIG. 8 the reflective image shown in FIG. 6 is overlaid on the simulated image of FIG. 7, which is an inverted blurred (Gausian radius 5 pixels) image of the upper display image multiplied by the original upper display image. It can be seen that local character contrast (e.g., in element 38a) is enhanced with turning on only a fraction of the lower display pixels, thus providing the desired power saving. Thus the embodiment illustrated in FIGS. 6-8 can improve character readability in dim or semi-bright conditions with lower power consumption. Thus for detecting high spatial frequency, high-contrast content, e.g. text or graphic art, the algorithm described herein may be applied selectively only where needed to improve readability.

Moreover, as was stated herein, the lower display may be any emissive, transmissive, reflective or transfective plane with non-zero reflectance. The upper display could utilize any spatial light-modulating technology, e.g., based on birefringence/retardation (LCD with polarizers), scattering (e.g. polymer-dispersed LCD), Bragg reflection (e.g. cholesteric LCDs), Fabry-Perot interference condition (e.g. MEMS), selective absorption (e.g. electro-chromic displays, anisotropic dye-doped LCDs), mechanical shutter matrix, or selective reflection such as tunable plasmonic devices. Furthermore, the displays could be dot matrix, multiplexed segment, and direct-drive iconic displays, and the upper display even optically, magnetically, or thermally addressed/activated.

Furthermore, not only the illuminance of the ambient light can be measured but also its diffusiveness/diffusivity to implement embodiments of the invention. The ambient light diffusivity determines how strong the shadows will be on the lower display. It was shown in US Patent Application Publication Number 2003/0133284 that adjusting the amount of diffusion of a reflective display can be done according to the diffusiveness of the ambient light. According to this reference, diffusivity of ambient light can be measured with an auto-focus sensor, e.g. built-in camera or a stand-alone sensor array. By measuring the contrast in the same way as autofocus sensors in through-the-lens (TTL) single-reflex 35 mm cameras, the amount of diffusivity can be deduced.

It is further noted the example shown in FIGS. 5a-5c is valid for collimated/point light sources in the indicated direction. If the ambient light source is located at a larger angle, the shadow will be larger (projection of the upper display pixel onto the lower display). Therefore, the lower display image depends on the ambient light source position, which can be readily measured with a detector.

On the other hand, completely diffusive/distributed ambient light will not result in shadows and hence there won't be any problem of parallaxed shadow according to the first embodiment described herein. In mixed illuminations (point and diffuse sources), the inverted reflected image shown on the lower display may be calculated differently, i.e., taking into consideration the first embodiment (FIGS. 5a-5c) and/or the second embodiment (FIGS. 6-8) In this case, the image on the lower display generally may be a combination of these two embodiments (e.g., contributions of the two terms corresponding to the ratio of diffuse/point light) or may only one embodiment out of the first and second embodiments should be performed based on a predetermined criterion.

For example, if the ambient light diffusive component is negligible/small and the collimated/point component in the ambient light is comparable/larger or much larger than the diffusive component (e.g. sun in a clear sky without reflecting objects in the vicinity), then the first embodiment (FIGS. 5a-5b) should be used. If, however, the collimated/point component in the ambient light is negligible/small and the ambient light diffusive component is larger/comparable or much larger than the collimated/point component, then the second embodiment (FIGS. 6-8) should be used (if the total ambient light illuminance is below the predefined threshold as stated above).

In a further embodiment, the methods disclosed in the first and second embodiments may be used for matching white point of the reflected ambient light for more accurate compensation (e.g., see U.S. Pat. No. 7,486,304 for dynamic color gamut). For example, if the spectrum of the ambient light is identified or its tristimulus or RGB components are measured, then the compensation (e.g., pixel emission/transmission of the lower displays) may follow each measured white point, thus providing a matching white point at the same time. Instead of matching white point, the lower display may generate a background image of a chroma and hue value (e.g., in the CIE L*a*b* color space) having the opposite sign and 180 degrees difference, respectively, of that of the reflected ambient light. In this way not only luminance contrast is maximized but also color contrast. For example, a reflective display in a yellowish illumination can enhance the color contrast by applying a blueish hue.

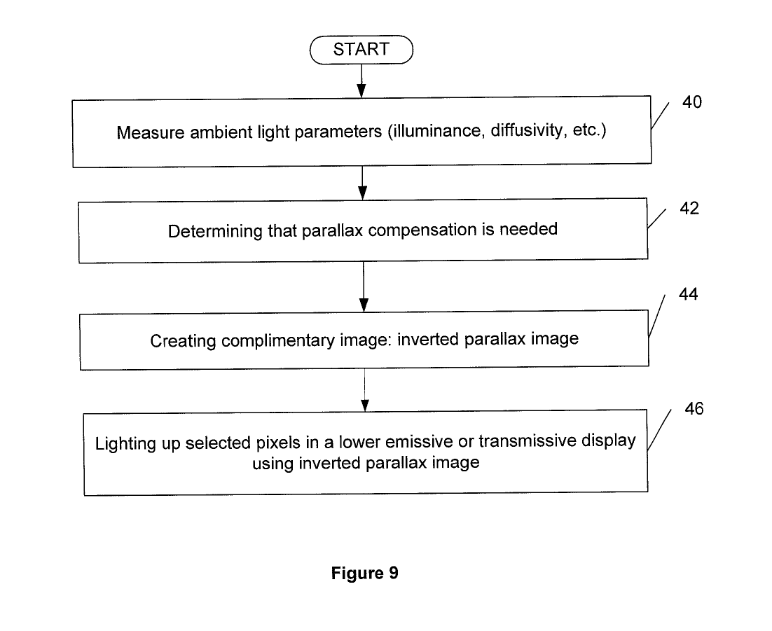

FIG. 9 shows an example of a flow chart demonstrating implementation of exemplary embodiments of the invention for eliminating parallax in the observed image in a reflective mode of a dual-image plane transflective display. It is noted that the order of steps shown in FIG. 9 is not absolutely required, so in principle, the various steps may be performed out of the illustrated order. Also certain steps may be skipped or selected steps or groups of steps may be performed in a separate application.

In a method according to this exemplary embodiment, as shown in FIG. 9, in a first step 40, ambient light parameters (luminance, diffusivity, white point, etc.) is measured by an electronic device comprising a transflective display. In a step 42, it is determined that parallax compensation is needed, e.g., when the ambient light diffusive component is negligible/small, the collimated/point component in the ambient light is comparable/larger or much larger than the diffusive component In a next step 44, an inverted parallax image (or a complimentary image which may be defined as a blurred inverted image of the upper display image multiplied by the original upper image) is created in the electronic device according to the first embodiment (FIGS. 5a-5c) as described herein. In a step 46, selected pixels in the lower display are lighted up using the inverted parallax image to eliminate parallax in the observed image.

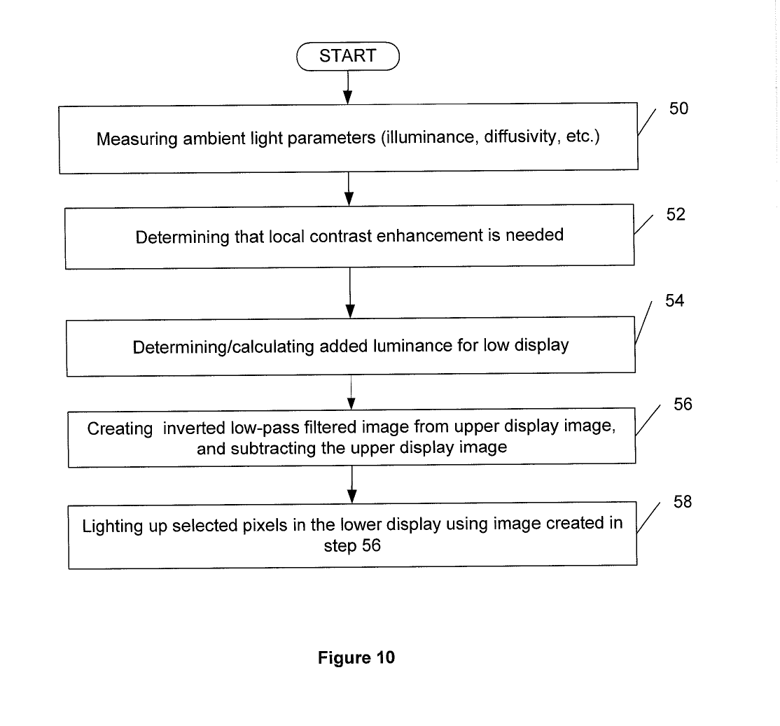

FIG. 10 shows an example of a flow chart demonstrating implementation of exemplary embodiments of the invention for local contrast enhancement in the reflective mode of a transflective display. It is noted that the order of steps shown in FIG. 10 is not absolutely required, so in principle, the various steps may be performed out of the illustrated order. Also certain steps may be skipped or selected steps or groups of steps may be performed in a separate application.

In a method according to this exemplary embodiment, as shown in FIG. 10, in a first step 50, ambient light parameters (luminance, diffusivity, white point, etc.) is measured by an electronic device comprising a transflective display. In a step 52, it is determined that local contrast enhancement is needed, e.g., when the collimated/point component in the ambient light is negligible/small and the ambient light diffusive component is larger or much larger than the collimated/point component and if the total ambient light illuminance is below the predefined threshold.

In a next step 54, add-on-luminance for the lower display is determined/calculated as described herein according to the second embodiment (FIGS. 6-8). In a next step 56, an inverted image for achieving local contrast enhancement (complimentary image) is created in the electronic device according to the second embodiment (FIGS. 6-8) as described herein. In a step 58, selected pixels in the lower display are lighted up using the inverted image for achieving local contrast enhancement in the observed image.

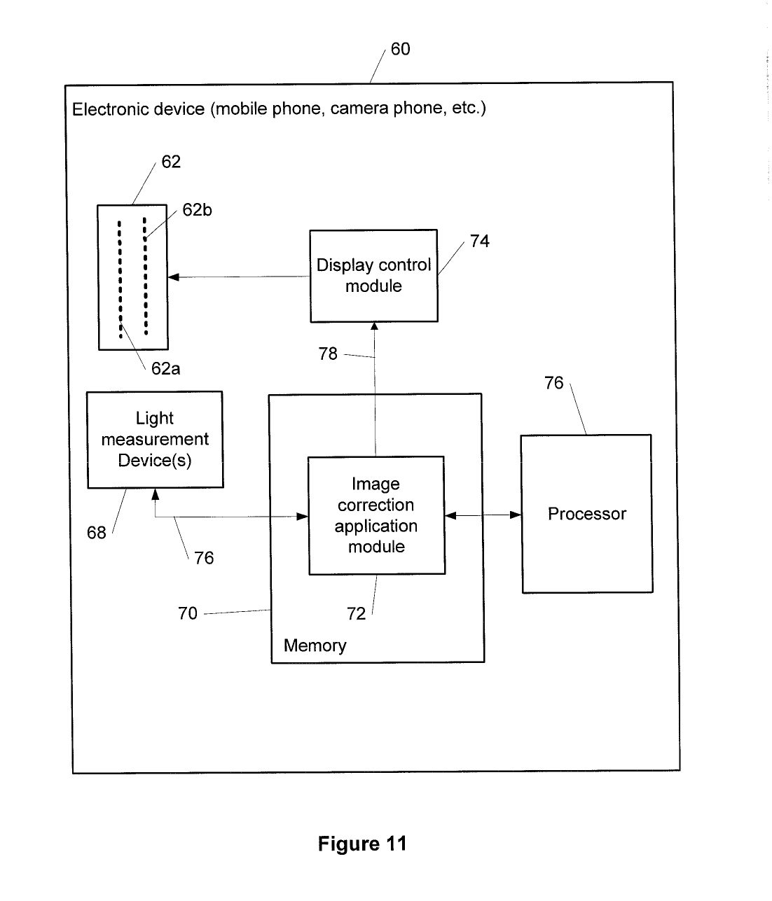

FIG. 11 shows an example of a simplified block diagram of an electronic device 60 comprising a transflective display 62 with an upper display 62a and a lower display 62b as described herein. FIG. 11 is a simplified block diagram of various electronic devices that are suitable for practicing the exemplary embodiments of this invention, e.g., in reference to FIGS. 5-10, and a specific manner in which components of an electronic device are configured to cause that electronic device 60 to operate. The electronic device 60 may be implemented as a portable or non-portable electronic device, a wireless communication device with a display, a camera phone, and the like.

The device 60 further comprises (ambient) light measurement device(s) 68 as described herein for implementing step 40 in FIG. 9 or step 50 in FIG. 10. The results of the ambient light measurements are communicated via link 76 to an image correction application module 72 which is configured to perform steps 42-44 in FIG. 9 and steps 52-56 in FIG. 10. The module 72 sends the command signal 78 (based on the created/determined complimentary image) to a display control module 74 for implementing step 46 in FIG. 9 and step 58 in FIG. 10.

The device 60 further comprises at least one memory 70 and at least one processor 76.

Various embodiments of the at least one memory 70 (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 76 include but are not limited to general purpose computers, special purpose computers, microprocessors, digital signal processors (DSPs) and multi-core processors.

The module 72 may be implemented as an application computer program stored in the memory 70, but in general it may be implemented as software, firmware and/or hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 72 may be implemented as a separate block or may be combined with any other module/block of the electronic device 60, or it may be split into several blocks according to their functionality

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

What is claimed is:

1. A method comprising:
measuring at least one of ambient light illuminance, ambient light diffusivity and an ambient light white point of ambient light incident on a transflective display having an upper display operating in a reflective mode;
creating at least one complimentary image based on the at least one of the measured ambient light illuminance and the measured ambient light diffusivity and ambient light white point; and
lighting up selected pixels in a lower display of the transflective display, using the at least one complimentary image.

2. The method of claim 1, wherein a parallax is removed in observed image of the transflective display.

3. The method of claim 2, wherein the complimentary image is an inverted image of a parallax image on the lower display.

4. The method of claim 3, wherein the parallax image is determined using the measured ambient light illuminance, a spectral reflectance of the lower display and a blurring parameter.

5. The method of claim 4, wherein the blurring parameter is a Gaussian blurred reflective display image on the lower display which is a function of a distance between the upper display and the lower display and a spatial distribution of ambient light.

6. The method of claim 5, wherein the spatial distribution of the ambient light is determined from a ratio of at least two spectral channels of the ambient light detected by a spectral light sensor.

7. The method of claim 2, wherein after the measuring the at least one of the ambient light illuminance, the ambient light diffusivity and the ambient light white point, the method further comprising:
determining if a parallax compensation or a local contrast enhancement of the observed image is needed based on predetermined criterion by comparing an ambient light diffusive component and a collimated/point component in the measured ambient light.

8. The method of claim 1, wherein a local contrast enhancement is performed in an observed image of the transflective display if the measured ambient light illuminance is below a predefined illuminance threshold.

9. The method of claim 8, wherein the complimentary image is a blurred and inverted version of the observed image where an amount of blur, a white level and a color of the complimentary image are determined by a size of at least one feature of interest comprising a high-contrast content and the ambient light illuminance and the ambient light white point

10. The method of claim 9, wherein the high-contrast content is a text.

11. The method of claim 9, wherein an add-on-luminance is determined based on the measured ambient light illuminance and the predefined luminance threshold.

12. The method of claim 11, wherein the selected pixels are determined from the complimentary image, and lighting levels of the selected pixels are determined using the add-on-luminance.

13. The method of claim 1, wherein the lower display is comprised of an emissive or transmissive display.

14. An apparatus comprising:
at least one processor and a memory storing a set of computer instructions, in which the processor and the memory storing the computer instructions are configured to cause the apparatus to:
measure at least one of ambient light illuminance, ambient light diffusivity and an ambient light white point of ambient light incident on a transflective display having an upper display operating in a reflective mode;
create at least one complimentary image based on the at least one of the measured ambient light illuminance and the measured ambient light diffusivity and ambient light white point; and
light up selected pixels in a lower display of the transflective display, using the at least one complimentary image.

15. The apparatus of claim 14, wherein a parallax is removed in observed image of the transflective display.

16. The apparatus of claim 15, wherein the complimentary image is an inverted image of a parallax image on the lower display.

17. The apparatus of claim 14, wherein a local contrast enhancement is performed in an observed image of the transflective display if the measured ambient light illuminance is below a predefined luminance threshold.

18. The method of claim 17, wherein the complimentary image is a blurred and inverted version of the observed image where an amount of blur, a white level and a color of the complimentary image are determined by a size of at least one feature of interest comprising a high-contrast content and the ambient light illuminance and the ambient light white point.

19. The apparatus of claim 14, wherein the lower display is comprised of an organic light emitting diode display.

20. A non-transitory computer readable memory encoded with a computer program comprising computer readable instructions recorded thereon for execution of a method comprising:
measuring at least one of ambient light illuminance, ambient light diffusivity and an ambient light white point of ambient light incident on a transflective display having an upper display operating in a reflective mode;
creating at least one complimentary image based on the at least one of the measured ambient light illuminance and the measured ambient light diffusivity and ambient light white point; and
lighting up selected pixels in a lower display of the transflective display, using the at least one complimentary image.
